(19) United States
(12) Patent Application Publication
(10) Pub. No.: US 2003/0040919 A1
(43) Pub. Date: Feb. 27, 2003

(54) Data calculation processing method and recording medium having data calculation processing program recorded thereon

(75) Inventors: Yasunaga Miyazawa, Okaya-shi (JP); Hiroshi Hasegawa, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/197,463

(22) Filed: Jul. 18, 2002

(30) Foreign Application Priority Data
Jul. 24, 2001 (JP) 2001-223611

(51) Int. Cl. G10L 19/00

(52) U.S. Cl. 704/500

(57) ABSTRACT

An output corresponding to input data, having a required precision, is obtained while reducing the amount of computation in data calculation that employs a complex function, such as calculation for obtaining an HMM output probability.

A range of possible input data x is divided into a segment A in which input data x can be safely replaced with a constant value, segments B and D in which some error is allowed in input data x, and a segment C in which a value corresponding to input data x must be obtained with high precision. It is determined which of the segments input data resides in, and an output value corresponding to the input data x, having a resolution in accordance with a segment determined, is obtained. More specifically, in the segment C, output values corresponding to possible values of input data x in the segment are pre-calculated; in the segments B and D, output values associated with the segments (the segments may be divided further) are pre-calculated; and in the segment A, a constant value is pre-calculated. These output values are allowed to be obtained by table reference.

### TECHNICAL FIELD

The present invention relates to a data calculation processing method that serves to simplify data calculation for obtaining an output value corresponding to input data by assigning the input data to a function including a complex algorithm, and in particular, it relates to a data calculation processing method and a recording medium having a data calculation processing program recorded thereon that are suitable for obtaining an HMM (Hidden Markov Model) output probability.

### BACKGROUND ART

Generally, in the technical field of information technology, etc., an output value corresponding to input data is obtained, for example, by assigning the input data to a function that requires a complex algorithm. An example of the above is an algorithm for obtaining an HMM output probability, which is used, for example, in speech recognition.

As a method of speech recognition based on HMM, a method based on continuous distribution HMM is well known. Speech recognition based on continuous distribution HMM achieves a high recognition rate; however, disadvantageously, the amount of computation is large. In particular, a large amount of computation is required for calculating an output probability in each state (state output probability) of HMM, and accordingly, problems exist such as a large memory area being required for computation.

Now, let an output probability of a transition from a state i to a state j with regard to a feature vector Y obtained at a time by speech analysis be denoted by bij(Y), and assuming a normal distribution with no correlation, bij(Y) can be expressed by equation (1) shown in FIG. 9.

The input vector Y is represented by components (e.g., LPC cepstrum) of a dimension n (n is a positive integer), obtained by analyzing input speech with a duration of, for example, 20 msec at each time (time t1, time t2, . . . ). Letting input vectors at time t1, t2, t3, . . . be denoted as Y1, Y2, Y3, . . . , the input vector Y1 at time t1 is denoted as (1y1, 1y2, . . . , 1yn), the input vector Y2 at time t2 as (2y1, 2y2, . . . , 2yn), the input vector Y3 at time t3 as (3y1, 3y2, . . . , 3yn), etc.

In the above equation (1), k represents the dimension of components of the input vector Y at a time, and it takes on one of the values 1 to n. σij(k) denotes variance in the dimension k in the case of state i to state j, and μij(k) denotes an average value in the dimension k in the case of state i to state j.

A disadvantage of equation (1) is that the amount of computation is extremely large. Particularly, in small, light, inexpensive products, which suffer severe hardware restrictions, it is substantially infeasible to perform a complex calculation such as equation (1) in a limited time.

As a method of overcoming the problem, a method in which scalar quantization is performed in calculation of an output probability has been proposed, for example, in Japanese Unexamined Patent Application Publication No. 9-6382.

FIG. 8 serves to explain scalar quantization. In an output probability distribution with regard to input data (a dimension k of feature vector) in a state (from state i to state j) of a phoneme HMM, feature data yk of the dimension k is in this case approximated by one of the values of codes C1, C2, . . . , and CM. In the example shown in FIG. 8, the feature data yk of the dimension k is replaced by the code Cm that is most approximate to the feature data yk, and a table prepared in advance is referred to based on the code Cm, whereby a probability of outputting (output probability of) the feature data yk of the dimension k is obtained.

As described above, scalar quantization allows an output probability of feature data of a dimension k to be obtained by table reference, and the amount of computation is considerably reduced compared with calculation using the complex equation given earlier. However, as will be understood from FIG. 8, the output probability obtained by table reference has an error Δε with respect to an actual value. The error Δε affects subsequent recognition process, degrading result of recognition.

This may be overcome by increasing table sizes and thereby minimizing quantization error. However, increased table sizes require allocation of a memory (ROM) area for storing the tables, raising a problem that a large memory is required.

Furthermore, although the method based on scalar quantization considerably reduces the amount of computation compared with calculation using the complex equation given earlier, the method based on scalar quantization still requires calculation for obtaining differences from respective codes and comparing the differences in order to determine which code is approximate to the input feature data (feature data of each dimension), and the amount of computation is extremely large in view of the entire input data to be processed.

Although the above description has been made in the context of an algorithm for obtaining an HMM output probability, which is employed, for example, in HMM speech recognition, the above problems generally apply to data processing for obtaining a value corresponding to input data by assigning the input data to a function that requires a complex algorithm.

Accordingly, it is an object of the present invention to allow calculation for obtaining a value corresponding to input data by assigning the input data to a function to be performed with a small amount of computation while allowing an output value to be obtained with high precision for a part that requires precision.

### BRIEF DESCRIPTIONS OF THE INVENTION

In order to achieve the above object, a data calculation processing method according to the present invention is a data calculation processing method that simplifies data calculation for obtaining an output value corresponding to input data by assigning the input data to a function, wherein a range of possible input data is divided at least into a segment in which an output value corresponding to the input data must be obtained with high precision and a segment in which some error is allowed, it is determined which segment the input data resides in, and an output value of a resolution in accordance with a segment determined is obtained.

In the data calculation processing method, the segment in which an output value corresponding to the input data must be obtained with high precision and the segment in which some error is allowed exist in association with combinations of high-order n bits (n is a positive integer, and is smaller than the number of bits N of the input data) of the input data in binary representation, and whether a segment associated with a combination of bits is the segment in which an output value corresponding to the input data must be obtained with high precision or the segment in which some error is allowed is predetermined.

A process of determining which segment the input data resides in and obtaining an output value of a resolution in accordance with a segment determined is executed by sequentially referring to tables of a group of hierarchically structured tables, and a process of sequentially referring to the hierarchically structured tables is such that a process of reading the high-order n bits of the input data in binary representation, referring to a top table of the group of hierarchically structured tables using contents of the n bits as a key, obtaining information of a table to be referred to next if a table to be referred to next is dictated in the top table and obtaining the number of bits to be read subsequent to the high-order n bits if the number of bits to be read is dictated in the top table, and referring to the table to be referred to using contents of bits of the input data corresponding to the number of bits to be read as a key is repeated until reaching a terminal table in which a table to be referred to next is not dictated, and the terminal table is referred to using contents of bits of the input data corresponding to the number of bits to be read as dictated in a table immediately preceding the terminal table as a key, thereby obtaining an output value corresponding to the input data.

Output values corresponding to input data in the segment in which an output value must be obtained with high precision are output values corresponding to individual possible values of input data in the segment, and the output values are dictated in a terminal table in association with the individual possible values of input data in the segment.

Output values corresponding to input data in the segment in which some error is allowed are an output value for the segment in which some error is allowed or output values for respective segments formed by further dividing the segment, and the output values are dictated in a terminal table in association with the respective segments.

An output value corresponding to input data in the segment in which some error is allowed may be obtained by approximating a function curve in the segment.

As a method of approximating the function curve, linear approximation may be used.

In addition to the segment in which an output value corresponding to the input data must be obtained with high precision and the segment in which some error is allowed, a segment in which a predetermined constant value is used as an output value corresponding to input data may be provided.

Data calculation for obtaining an output value corresponding to input data according to a predetermined algorithm by assigning the input data to a function may be used for calculation for obtaining an output probability in an HMM.

A recording medium having recorded thereon a data calculation processing program according to the present invention is a recording medium having recorded thereon a data calculation processing program that simplifies data calculation for obtaining an output value corresponding to input data by assigning the input data to a function. According to the data calculation processing program, a data calculation processing method is such that a range of possible input data is divided at least into a segment in which an output value corresponding to the input data must be obtained with high precision and a segment in which some error is allowed, it is determined which segment the input data resides in, and an output value of a resolution in accordance with a segment determined is obtained.

In the recording medium having recorded thereon the data calculation processing program, the segment in which an output value corresponding to the input data must be obtained with high precision and the segment in which some error is allowed exist in association with combinations of high-order n bits (n is a positive integer, and is smaller than the number of bits N of the input data) of the input data in binary representation, and whether a segment associated with a combination of bits is the segment in which an output value corresponding to the input data must be obtained with high precision or the segment in which some error is allowed is predetermined.

A process of determining which segment the input data resides in and obtaining an output value of a resolution in accordance with a segment determined is executed by sequentially referring to tables of a group of hierarchically structured tables, and a process of sequentially referring to the hierarchically structured tables is such that a process of reading the high-order n bits of the input data in binary representation, referring to a top table of the group of hierarchically structured tables using contents of the n bits as a key, obtaining information of a table to be referred to next if a table to be referred to next is dictated in the top table and obtaining the number of bits to be read subsequent to the high-order n bits if the number of bits to be read is dictated in the top table, and referring to the table to be referred to using contents of bits of the input data corresponding to the number of bits to be read as a key is repeated until reaching a terminal table in which a table to be referred to next is not dictated, and the terminal table is referred to using contents of bits of the input data corresponding to the number of bits to be read as dictated in a table immediately preceding the terminal table as a key, thereby obtaining an output value corresponding to the input data.

Output values corresponding to input data in the segment in which an output value must be obtained with high precision are output values corresponding to individual possible values of input data in the segment, and the output values are dictated in a terminal table in association with the individual possible values of input data in the segment.

Output values corresponding to input data in the segment in which some error is allowed are an output value for the segment in which some error is allowed or output values for respective segments formed by further dividing the segment, and the output values are dictated in a terminal table in association with the respective segments.

An output value corresponding to input data in the segment in which some error is allowed may be obtained by approximating a function curve in the segment.

As a method of approximating the function curve, linear approximation may be used.

In addition to the segment in which an output value corresponding to the input data must be obtained with high precision and the segment in which some error is allowed, a segment in which a predetermined constant value is used as an output value corresponding to input data may be provided.

Data calculation for obtaining an output value corresponding to input data according to a predetermined algorithm by assigning the input data to a function may be used for calculation for obtaining an output probability in an HMM.

As described above, according to the present invention, a range of possible input data x is divided at least into a segment in which a output value corresponding to the input data must be obtained with high precision and a segment in which some error is allowed, it is determined which segment the input data resides in, so that an output value of a resolution in accordance with a segment determined is obtained. Accordingly, data for output values is reduced to a necessary amount, serving to reduce a memory area occupied for storing data.

Furthermore, since an output of a resolution in accordance with input data is obtained, an output for input data that requires precision is obtained with high precision while an output for input data that allows some error is obtained within an allowable range of error. Accordingly, subsequent data processing using the output value is executed with high precision.

Furthermore, by predetermining whether a segment corresponding to a combination of high order n bits of input data is a segment in which an output data corresponding to the input data must be obtained with high precision or a segment in which some error is allowed, which of the segments the input data resides in can be determined based on contents of high-order n bits of input data.

A process for determining which of the segments the input data resides in and obtaining an output value of a resolution in accordance with a segment determined is implemented only by sequential reference to hierarchically structured tables, so that an output value corresponding to the input data can be obtained simply and quickly.

Furthermore, output values corresponding to input data in the segment in which an output value must be obtained with high precision are output values corresponding to individual possible value of input data in the segment, and the output values are provided in a table, so that an output value corresponding to input data is obtained with high precision, and furthermore, the output value is obtained only by table reference.

Furthermore, output values corresponding to input data in the segment in which some error is allowed are an output value for the segment in which some error is allowed or output values for respective segments formed by further dividing the segment, so that only data of representative values of the respective segments suffices for the segment in which some error is allowed, serving to save inefficiency in table sizes. Furthermore, since an output value corresponding to input data residing in each segment is obtained only by table reference, comparison calculation for finding a code approximate to input data, which has been required in conventional scalar quantization, is unnecessary, so that the amount of computation is reduced.

Furthermore, an output value corresponding to input data in the segment in which some error is allowed may be obtained by approximation of a function curve in the segment. This also serves to reduce the amount of computation compared with direct calculation of a function, and furthermore, an output value corresponding to input data is obtained with good precision.

A method of approximating the function curve is linear approximation, and the amount of computation can be further reduced by employing linear approximation.

In addition to the segment in which an output value corresponding to input data must be obtained with high precision and the segment in which some error is allowed, a segment in which a predetermined constant value is used as an output value corresponding to input data is provided. Since precision is not required in that segment, replacement with the constant value does not particularly cause a problem in subsequent processing, so that the amount of computation is further reduced.

Furthermore, the present invention can be applied to calculation of an output probability in an HMM. Accordingly, an output probability of feature data that requires precision is obtained with high precision while an output probability of feature data that allows some error is obtained within an allowable range of error, that is, an output probability of a resolution in accordance with input feature data is obtained.

A process for obtaining an output probability can be implemented by only sequential reference to hierarchically structured tables or simple approximating calculation. Accordingly, an output probability is obtained quickly with a small amount of computation. In addition, elimination of values of unnecessary output probabilities is advantageous, particularly in that occupancy of memory area is reduced. Furthermore, an output probability is obtained with high precision for a part that requires precision, achieving a good ability of recognition.

### BRIEF DESCRIPTION OF THE DRAWINGS

FIG. 1 is a diagram showing an example function curve for explaining a basic process of the present invention.

FIG. 2 is a flowchart for explaining the basic process of the present invention.

FIG. 3 is an example of hierarchically structured tables created for the function curve in FIG. 1.

FIG. 4 is a diagram for explaining an example in which an output corresponding to input data is obtained by linearly approximating a segment that allows some error in the function curve shown in FIG. 1.

FIG. 5 is a diagram for explaining an example in which an output corresponding to input data is obtained by further dividing the segment shown in FIG. 4 and linearly approximating each segment.

FIG. 6 is a diagram for explaining an example in which the present invention is applied to a process for calculating an HMM output probability, and it is a diagram showing distribution of HMM output probability in a state.

FIG. 7 is a diagram for explaining an example in which the present invention is applied to a process of obtaining an output probability of a mixed continuous distribution HMM, and it shows distribution of output probability of a mixed continuous HMM in a state.

FIG. 8 is a diagram for explaining a method of obtaining an output probability of feature data using conventional scalar quantization.

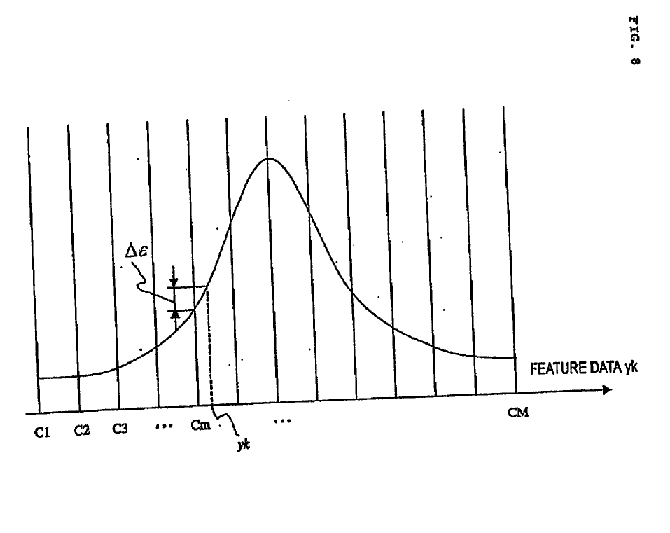

FIG. 9 is a diagram showing equation (1) representing bij(Y), which is an output probability in a transition from a state i to a state j with regard to a feature vector Y obtained at a time by speech analysis.

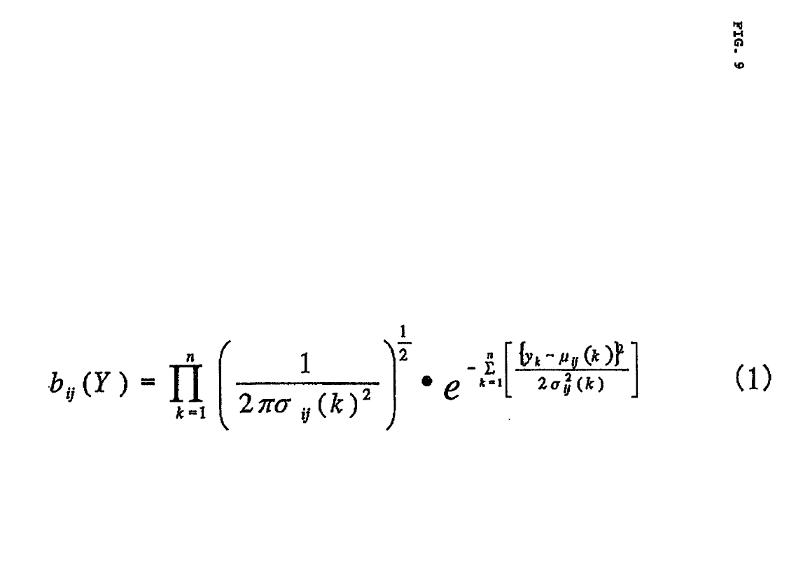

### BEST MODE FOR CARRYING OUT THE INVENTION

Embodiments of the present invention will now be described. The description of the embodiments relates to a data calculation processing method according to the present invention and also to content of a data calculation processing program recorded on a recording medium.

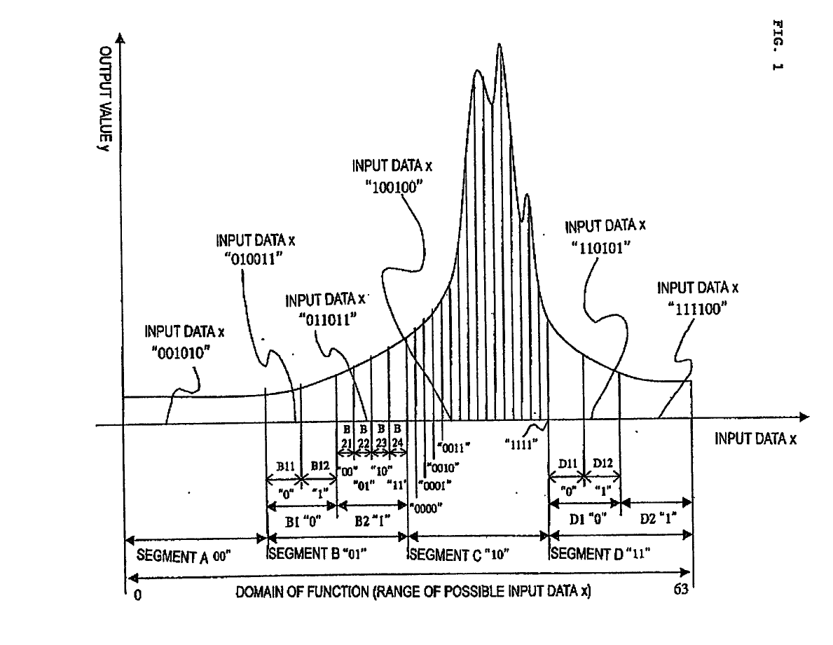

First, a basic process of a data calculation method according to the present invention will be described with reference to FIG. 1. FIG. 1 shows a curved line represented by a function that yields an output value y corresponding to input data x by a complex algorithm. Input data x herein is represented in six bits. Thus, the domain of the function is 0 to 63 in decimal representation.

An object of the present invention is to obtain an output value y corresponding to input data x by a small amount of computation, and with high precision for a part that requires precision. According to the present invention, precision of an output value corresponding to input data is varied depending on where in the domain of the function the input data resides.

That is, a range of possible input data (the domain of the function) is divided into at least a segment in which an output value corresponding to input data must be obtained with high precision and a segment in which some error is allowed, and it is determined which segment the input data resides in, obtaining an output value of a resolution in accordance with a segment determined. Two methods (a first method and a second method) for the above according to the present invention will be described.

First, a first method will be described. According to the first method, an output value y corresponding to input data x is obtained only by table reference.

Broadly speaking, in the domain of a function for processing data, if input data x resides in a segment in which an output value corresponding to the input data x must be obtained with high precision, an output value y corresponding to the input data x is obtained by referring to tables that allow an output value y corresponding to a value of input data x to be obtained with high precision. If the input data x resides in a segment in which some error is allowed in an output value corresponding to a value of the input data x, an output value y corresponding to the input data x is obtained by referring to tables associated with the segment. If the input data x resides in a segment in which an output value corresponding to the input data x can be safely set to a constant value, input data residing in the segment is replaced with the constant value.

Considering the above with reference to FIG. 1, for example, in a range of possible input data x, a segment A is such that an output value corresponding to input data x residing in the segment A can be safely set to a constant value; a segment B is such that some error is allowed in an output value corresponding to a value of input data x; a segment C is such that an output value corresponding to input data x must be obtained with high precision; and a segment D is such that, similarly to the segment B, some error is allowed in an output value corresponding to a value of input data x.

That is, according to this embodiment, a part where change in output value y in relation to input data x is intense is determined as a segment in which an output value corresponding to input data x must be obtained with high precision; a part where change in y in relation to input data x is not so intense is determined as a segment in which some error is allowed in an output value corresponding to a value of input data x; and a part where y does not substantially change in relation to input data x is determined as a segment in which an output value corresponding to input data x can be safely set to a constant value.

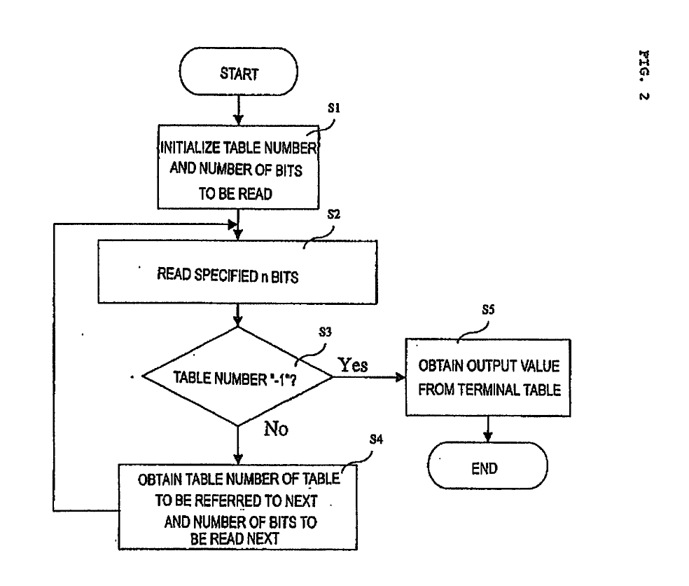

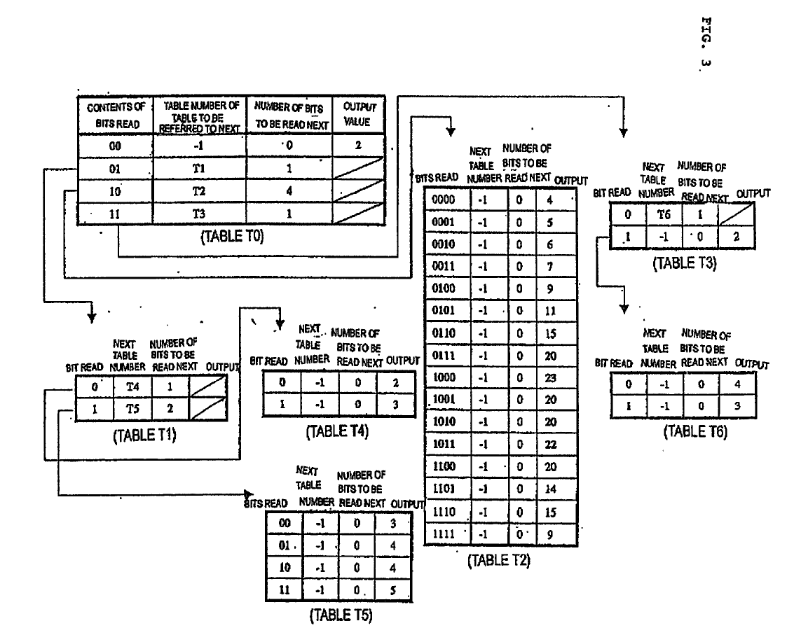

A specific example process will be described below with reference to a flowchart shown in FIG. 2 and tables T0 to T6 shown in FIG. 3. The tables T0 to T6 are hierarchically structured. First, the table T0 at the top of the hierarchy is referred to, and tables at subsequent levels are sequentially referred to as dictated by content of the table T0.

The tables T0 to T6 include data description fields for contents of bits read from input data x, the table number of a table to be referred to next, the number of bits to be read next, and an output value obtained in relation to input data x. Examples of reference to the tables T0 to T6 will be described below together with a processing procedure.

Now, let it be supposed that input data x is represented in six bits as described earlier and that input data x of “011011” is input.

Let it be supposed that setting is made such that where in the domain the input data x of “011011” resides is determined by checking the high-order two bits.

That is, in this case, using the high-order two bits, which of four equally divided segments (the segments A, B, C, and D in FIG. 1) of the domain (0 to 63) the input data x resides in is determined. In this example, first, the table T0 is referred to using the high-order two bits as a key, and processes based on content of the table T0 are sequentially executed.

Furthermore, let it be supposed herein that association between combinations of the high-order two bits of input data x (“00”, “01”, “10”, and “11”) and the segments A, B, C, and D described earlier is high-order two bits “00” to the segment A, high-order two bits “01” to the segment B, high-order two bits “10” to the segment C, and high-order two bits “11” to the segment D.

Referring first to the flowchart shown in FIG. 2, table number and number of bits to be read are initialized (step s1), and specified n bits (high-order two bits in this case) of the input data of “011011” is read (step s2). Since the high-order two bits are read as “01”, the table T0 shown in FIG. 3 is referred to using the high-order two bits “01” as a key, obtaining table information (table number) indicating a table to be referred to next and the number of bits to be read next.

More specifically, in this case, “T1” is obtained as the table number of a table to be referred to next, and “1” is obtained as the number of bits (the number of bits subsequent to the high-order two bits) to be read next. In the tables T0 to T6 shown in FIG. 3, “−1” in the field of table number indicates that reference to tables at subsequent levels will not be made. In that case, a table currently being referred to serves as a terminal table, and an output value corresponding to the input data x is obtained based on the terminal table.

When the high-order two bits “01” of the input data are first read and the table T0 is referred to using the high-order two bits “01” as a key, “T1” is obtained as the table number of a table to be referred to next and “1” is obtained as the number of bits to be read next. Then, in this case, since the input data x is “011011” and the value of one bit (one bit subsequent to the high-order two bits “01”) that is read as dictated by the table T0 is “1”, the table T1 is referred to using the value “1” of the one bit that has been read as a key, obtaining “T5” as the table number of a table to be referred to next and “2” as the number of bits to be read next.

That is, in this case, referring to the flowchart shown in FIG. 2, when the table T1 is referred to, it is determined whether the table number of a table to be read next, indicated in the table T1, is “−1” (step s3). Since the table number of a table to be referred to next is not “−1” yet, table reference is not finished, and “T5” is obtained as the table number of a table to be referred to next and “2” is obtained as the number of bits to be read next (step s4).

Returning to step s2, this time, bits of the input data are read according to the number of bits to be read, obtained in step s4 (two bits “01” subsequent to “011” in this case). Then, the table T5 is referred to using “01” that has been read as a key, obtaining “−1” as the table number of a table to be referred to next. Thus, it is determined that reference to tables at subsequent levels is not needed (the number of bits to be read next is “0”).

Accordingly, the table T5 serves as a terminal table, and an output value corresponding to the input data x is obtained based on the table T5. The table T5 indicates an output value of “4”, so that “4” is obtained as an output value corresponding to the input data x (step s5).

The above process will now be described with reference to FIG. 1. First, since the high-order two bits of the input data x of “011011” are “01”, the input data is determined as residing in the segment B of the domain of the function. In this case, the segment B is such that some error in an output value corresponding to the input data x is allowed.

The table T0 dictates that one bit subsequent to the high-order two bits be read in the segment B, so that the segment B can be considered as equally divided into two segments B1 and B2. In this case, the segment B1 corresponds to the value of the one bit subsequent to the high-order two bits being “0” while the segment B2 corresponds to the value of the one bit subsequent to the high-order two bits being “1”.

In the above example of the input data x of “011011”, the value of the one bit subsequent to the high-order two bits is “1”, which corresponds to the segment B2. In this case, the table T1 dictates that subsequent two bits be read further. Thus, the input data x is assumed as residing in one of equally divided four segments B21, B22, B23, and B24 of the segment B2.

In this case, the contents of bits of the input data corresponding to the number of bits “2” to be read as dictated by the table T1 are “01” (two bits subsequent to “011”), the input data x “011011” is determined as residing in the segment B22.

The table T5 is referred to using the two bits “01” that have been read as a key, finding that the table T5 dictates that no further table reference be made and an output value corresponding to the input data x be obtained at this level. The table T5 indicates “4” as an output value corresponding to the input data x, so that an output value of “4” is obtained for the input data x.

That is, in this case, the input data “011011” is determined as residing in the segment B22, and an output value of “4” is obtained for any input data x residing in the segment B22.

As will be understood from the table T5, for each of the segments B21, B22, B23, and B24, a value corresponding to input data x is calculated in advance. According to the table T5, output values are calculated for the respective segments such that an output value of “3” is obtained for input data x residing in the segment B21, an output value of “4” is obtained for input data x residing in the segment B22, an output value of “4” is obtained also for input data x residing in the segment B23, and an output value of “5” is obtained for input data x residing in the segment B24.

Although the output values for the respective segments have some error with respect to actually calculated values in some cases, since some error is allowed in the segment B, the output values are practically acceptable.

In the above example, if the value of the one bit subsequent to the high-order two bits of the input data is “0”, that is, if the input data x is “010011”, the table T1 is referred to using “0” as a key. In that case, since the value of the one bit subsequent to the high-order two bits of the input data x is “0”, the input data x of “010011” is determined as residing in B1 of the segment B in FIG. 1.

Furthermore, in this case, the table T1 dictates that the table T4 be referred to next and one bit be read, the input data x of “010011” is assumed as residing in one of equally divided two segments B11 and B12 of the segment B1. In this case, the content of the bit of the input data, corresponding to the number of bits “1” to be read as dictated by the table T1, is “0” (one bit subsequent to “010”), so that the input data x of “010011” is determined as residing in the segment B11.

Then, the table T4 is referred to using “0” as a key. The table T4 indicates “−1” as the table number of a subsequent table, so that no subsequent table reference is made, and an output value is obtained using the table T4 as a terminal table. In this case, since the output value is defined as “2”, “2” is determined as an output value for the input data “010011”.

Thus, the input data x of “010011” is determined as residing in the segment B11, and an output value of “2” is obtained for any input data x residing in the segment B11.

As will be understood from the table T4, for each of the segments B11 and B12, a value corresponding to input data x is calculated in advance. According to the table T4, output values are calculated for the respective segments such that an output value of “2” is obtained for input data x residing in the segment B11 and an output value of “3” is obtained for input data x residing in the segment B12.

Although the output values for the respective segments B11 and B12 have some error with respect to actually calculated values in some cases, since some error is allowed in the segment B, the output values are practically acceptable. The segment B1 is more susceptible to larger error than the segment B2.

Next, a case where input data x is “100100” will be considered. First, the high-order two bits are read, which is “10” in this case. Then, the table T0 is referred to using “10” as a key, obtaining “T2” as the table number of a table to be referred to next and “4” as the number of bits to be read next.

Since the value of the four bits that have been read (four bits subsequent to the high-order two bits “10”) is “0100”, the table T2 is referred to using the value “0100” of the four bits that have been read as a key, obtaining “−1” as the table number of a table to be referred to next. Accordingly, table reference is finished at this level, and an output value of “9” is obtained for the input data x using the table T2 as a terminal table.

Thus, the high-order two bits “10” of the input data x correspond to the segment C in the example shown in FIG. 1. In the segment C, it is required that an output value corresponding to the input data x be obtained with high precision. In this case, data can be obtained for each of the sixteen values of the input data x in the segment C (one of equally divided four segments of the range of possible input data 0 to 63).

Next, a case where input data x is “110101” will be considered. First, the high-order two bits are read, which are “11” in this case. Then, the table T0 is referred to using “11” as a key, obtaining “T3” as the table number of a table to be referred to next and “1” as the number of bits to be read next.

Since the value of the one bit that has been read (one bit subsequent to the high-order two bits “11”) is “0”, the table T3 is referred to using the value “0” of the one bit that has been read as a key, obtaining “T6” as the table number of a table to be referred to next and “1” as the number of bits to be read next.

Since the bit to be read (the bit subsequent to the high-order bits “110”) is “1” in this case, the table T6 is referred to using “1” as a key, obtaining “−1” as the table number of a table to be referred to next, so that it is determined that reference to tables at subsequent levels need not be made.

Thus, a value corresponding to the input data x is obtained using the table T6 as a terminal table. According to the table T6, a value of “3” is obtained, which serves as an output value corresponding to the input data x.

The process for the input data x of “110101” will be described with reference to FIG. 1. First, since the high-order two bits of the input data x of “110101” are “11”, the input data x is determined as residing in the segment D. The segment D is such that some error in an output value corresponding to the input data x is allowed.

Since the number of bits to be referred to next to the high-order two bits is one bit in the segment D, the segment D can be considered as further divided equally into two segments D1 and D2.

In this case, the segment D1 corresponds to the one bit subsequent to the high-order two bits being “0” while the segment D2 corresponds to the one bit subsequent to the high-order two bits being “1”. In the above example, the one bit subsequent to the high-order two bits is “0”, which corresponds to the segment D1. In this case, the table T3 dictates that the subsequent one bit be read further, so that the input data x can be assumed as residing in one of equally divided two segments D11 and D12 of the segment D1.

Since the value of the one bit that has been read (one bit subsequent to the high-order bits “110”) is “1”, the input data is determined as residing in the segment D12. Then, the table T6 is referred to using “1” as a key, obtaining “−1” as the table number a table to be referred to next. Accordingly, reference to subsequent tables is not made, and a value of “3” is obtained for the input data x using the table T6 as a terminal table.

That is, for each of the segments D11 and D12, a value corresponding to input data x is calculated in advance. According to the table T6, data values in which some error is allowed with respect to actually calculated values is obtained for the respective segments such that “4” is obtained for input data x in the segment D1 and “3” is obtained for input data x in the segment D12.

In the above example, if the value of the one bit subsequent to the high-order two bits of the input data x is “1”, that is, if the input data x is “111101”, since the table T3 indicates “−1” as a table to be referred to next, no further table reference is made, and an output value of “2” is obtained for the input data x using the table T3 as a terminal table.

The value “1” of the one bit subsequent to the high-order two bits of the input data corresponds to the segment D2 formed by dividing the segment D. When the input data x resides in the segment D2, “2” is uniformly used as a value corresponding to the input data x.

Next, a case where input data x is “001010” will be considered. First, the high-order two bits are read, which are “00” in this case. Then, the table T0 is referred to using “00” as a key, obtaining “−1” as the table number of a table to be referred to next. In this case, subsequent table reference is not made, and an output value of “2” is directly obtained for the input data x using the top table T0 as a terminal table.

When the high-order bits are “00” as above, the input data resides in the segment A in FIG. 1. Since the setting is such that a constant value is output for input data x in the segment A, in this case, if input data x resides in the segment A, a preset value of “2” is uniformly output.

Hereinabove, a method of obtaining an output y corresponding to input data x, having a resolution in accordance with the input data x, by using a function with reference to hierarchically structured tables has been described.

According to the first method, an output value y corresponding to input data x can be calculated only by referring to tables without directly calculating a complex function. Furthermore, an output value corresponding to input data x that requires precision can be obtained with high precision while allowing some error in an output value corresponding to input data x for which some error is allowed; that is, an output of a resolution in accordance with input data x is obtained. Accordingly, inefficiency in table sizes is saved.

The first method can be considered as a kind of scalar quantization. However, the first method differs from conventional scalar quantization in that, when determining a representative value corresponding to input data, conventional scalar quantization requires, for each input data x, operation for comparing the input data with representative values to determine a most approximate representative value, which is not required according to the first method. Furthermore, a feature of the first method is that an output value corresponding to input data x can be obtained only by making table reference several times at most, so that calculation for comparison, such as subtraction, is unnecessary.

Next, a second method will be described. According to the second method, in a segment in which some error is allowed (e.g., the segment B in FIG. 1, described in relation to the first method), an output corresponding to input data is obtained by approximating a function curve in the segment. A specific example thereof will be described below with reference to FIG. 1 and the tables in FIG. 3 referred to for the first method described earlier. Description herein will be made in the context of an example where linear approximation, in which the amount of computation is small, is used as a method of approximating a function curve.

In this example, if input data x resides in the segment C (a segment in which an output value with high precision is required), similarly to the example described earlier, an output value corresponding to the input data x is obtained using the tables T0 and T2. If the input data x resides in other segments, an output corresponding to the input data is obtained by linear approximation of a function curve or a constant value is output for the input data x.

For simplicity of description, let it be supposed herein that setting is made such that if input data x resides in the segment B or the segment D, an output corresponding to the input data x is obtained by linear approximation of a function curve in that segment, and if input data x resides in the segment A, a constant value is output for the input data x.

Also in the second method, it must be determined which segment input data x resides in, which is determined in this embodiment by reading the high-order two bits of the input data x as described earlier. For example, if the input data x is “011011”, the high-order two bits are “01”, so that the input data x resides in the segment B.

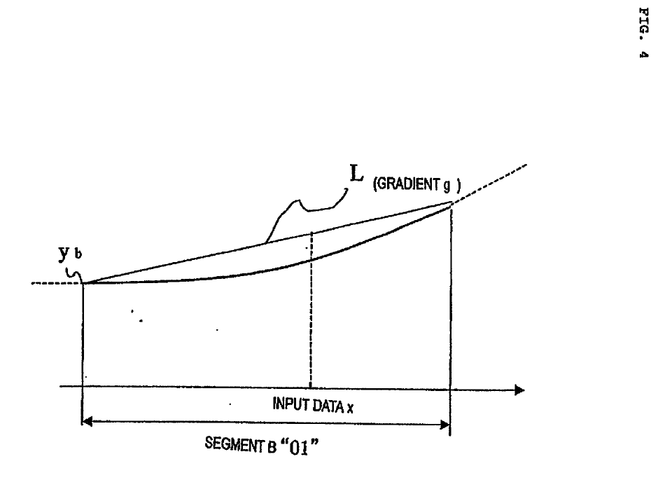

If the input data x resides in the segment B as described above, in this example, an output corresponding to the input data is obtained by linear approximation of a function curve in the segment. As shown in FIG. 4, the segment B is linearly approximated by a straight line L and the gradient g of the straight line L is obtained, and an output value corresponding to the input data x residing in the segment B is obtained using a pre-calculated representative value (e.g., a pre-calculated representative value yb for an output corresponding to the beginning point of the segment B) and the gradient g of the straight line L.

The method of obtaining an output corresponding to input data x by linear approximation is not specifically limited according to the present invention, and various methods may be used. An output is similarly obtained when the input data x resides in the segment D.

Furthermore, although description has been made in the context of an example where each of the segments B and D is linearly approximated as a single segment, an output corresponding to input data x may be obtained by further dividing each of the segments B and D and performing linear approximation for each of the divided segments.

For example, as described in relation to the first method, the segment B1 is equally divided into the two segments B1 and B2, and the segment B2 is further divided equally into the four segments B21, B22, B23, and B24. As such, the method may be such that each of the segments is divided and a function curve of each of the divided segments is linearly approximated.

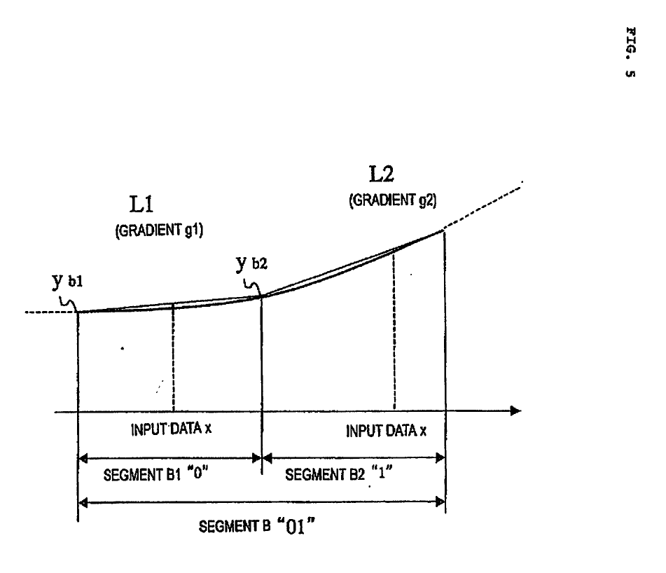

FIG. 5 shows an example in which the segment B is equally divided into the two segments B1 and B2 and in which the segments B1 and B2 are linearly approximated by straight lines L1 and L2, respectively. In this case, representative values yb1 and yb2 and gradients g1 and g2 for the respective segments B1 and B2 are pre-calculated, and outputs corresponding to input data x residing in the segments B1 and B2 are obtained using the representative values yb1 and yb2 and the gradients g1 and g2, respectively.

As described above, according to the second method, similarly to the first method, an output y corresponding to input data x is obtained only by table reference or by simple calculation for obtaining an approximate value in addition to table reference without directly calculating a complex function.

Although linear approximation, in which the amount of computation is small, is used for approximating a functional curve in the second method, it is to be understood that approximation methods other than linear approximation may be used. For example, if higher precision is required, an approximation method called the Simpson method may be used, with somewhat larger amount of computation compared with linear approximation. Although approximation by the Simpson method requires somewhat larger amount of computation, the amount of computation is smaller compared with the conventional calculation method described earlier, and precision is practically adequate.

The first and second methods have been described as such that an output must be obtained with high precision in a segment where change in a functional curve is intense while some error is allowed in a segment where change is not so intense. However, without limitation thereto, for example, it is possible that an output must be obtained with high precision in a segment in which change is not so intense or some error is allowed in a segment in which change is intense, so that setting as to which segment requires high precision and which segment allows some error can be arbitrarily made.

Hereinabove, basic processes of the present invention have been described. The present invention serves to achieve good results when applied to a process for calculating an HMM output probability, which is used, for example, for speech recognition.

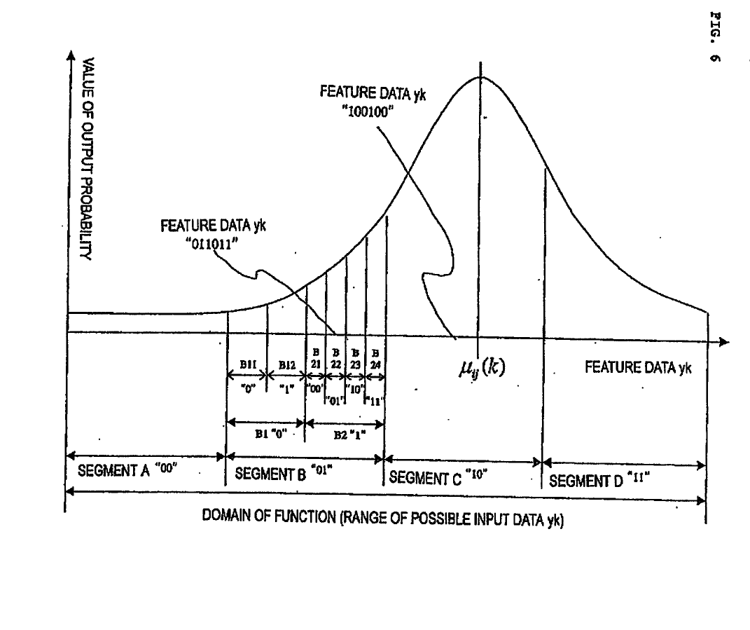

FIG. 6 shows a distribution of output probability in relation to input data (feature data of a dimension of a feature vector obtained at a time by speech analysis) in a state (state i to state j) of a phoneme HMM, which can be considered as corresponding to the function curve shown in FIG. 1 and described earlier. In the distribution of output probability, an output probability in relation to input data (feature data yk of a dimension k) is obtained using the first method or the second method described earlier.

Similarly to the first and second methods described earlier, the feature data yk is represented in six bits, and for convenience of description, a range of values that the feature data is allowed to take on (domain of function) is divided into four segments A, B, C, and D, similarly to FIG. 1.

The segment A is in the vicinity of an edge of the distribution of output probability, in which output probability does not substantially change; the segment B is such that change in output probability is rather gentle and frequency of occurrence of feature data is not so high; the segment C is such that change in output probability is intense and frequency of occurrence of feature data is high (a segment around the average μij(k) of the distribution of output probability); and the segment D is such that change in output probability is rather gentle and frequency of occurrence of feature data is not so high, similarly to the segment B.

Assuming that the segments A, B, C, and D in FIG. 6 correspond to the segments A, B, C, and D in FIG. 1, the segment A in FIG. 6 corresponds to the segment A in FIG. 1, the segment B in FIG. 6 corresponds to the segment B in FIG. 1, the segment C in FIG. 6 corresponds to the segment C in FIG. 1, and the segment D in FIG. 6 corresponds to the segment D in FIG. 1.

Thus, setting is made for each of the segments so that an output probability is obtained with high precision if feature data yk of a dimension k, which serves as input data, resides in the segment C; an output probability with a certain degree of precision, in which some error is allowed, is obtained if the feature data yk resides in the segment B or the segment D; and a predetermined constant output probability is obtained if the feature data yk resides in the segment A.

Specific processing operation may be implemented by either the first method or the second method described earlier. For example, since feature data yk of a dimension (dimension k), constituting a feature vector Yt at a time t, corresponds to input data x used in the first method or the second method, if the feature data yk is “011011”, an output probability corresponding to the feature vector yk is obtained by executing the same process as described earlier.

Although actually a table corresponding to the distribution of output probability of HMM is created and the process is executed based on the table, for convenience, description will be made using the same table as in the first method described earlier.

Of the feature data yk of “011011”, the high-order two bits are read. In this case, since the high-order two bits are “01”, the table T0 shown in FIG. 3 is referred to using the high-order two bits “01” as a key, obtaining “T1” as the table number of a table to be referred to next and “1” as the number of bits to be read next.

Based on the table T1, using the value “1” of the one bit (one bit subsequent to the high-order two bits “01”) that has been read as a key, the table T5 is obtained as a next table to be referred to and “2” is obtained as the number of bits to be read next.

Then, the table T5 is referred to using the two bits (two bits “01” subsequent to “011” in this case) that have been read as a key, in which “−1” is dictated as the table number of a table to be referred to next, so that an output probability for the feature data yk is obtained at this level.

The process will now be described with reference to FIG. 6. First, since the high-order two bits of the feature data yk having a value of “011011” are “01”, it is determined that the feature data yk is input data residing in the segment B. The segment B is such that some error is allowed in a value obtained for input data x.

Since the number of bits to be read subsequent to the high-order two bits is one bit in the segment B, the segment B can be considered as further divided equally into two segments B1 and B2. In this case, the segment B1 corresponds to the value of the one bit subsequent to the high-order two bits being “0” while the segment B2 corresponds to the value of the one bit subsequent to the high-order two bits being “1”.

In the example of the feature data yk of “011011”, the value of the one bit subsequent to the high-order two bits is “1”, which corresponds to the segment B2. In this case, the table T1 dictates that subsequent two bits be read further, so that the feature data yk can be assumed as residing in one of four segments B21, B22, B23, and B24 of the segment B2 (the feature data yk resides in the segment B22).

Then, the table T5 is referred to using the two bits “01” that have been read as a key, which dictates that no further table reference be made, so that an output probability for the feature data yk is obtained at this level. That is, in this case, the feature data yk of “011011” is determined as residing in the segment B22, and the same output probability is obtained for any feature data residing in the segment B22. Thus, an output probability for the feature data yk is obtained only by table reference.

Since the broad segment B allows some error, an output probability with some error is obtained if the feature data yk resides in the segment B; however, this does not significantly affect result of speech recognition.

Next, a case where the feature data yk is “100100” will be considered. In this case, since the high-order two bits are “10”, the table T0 is referred to using “10” as a key, obtaining “T2” as the table number of a table to be referred to next and “4” as the number of bits to be read next.

Since the value of the four bits (four bits subsequent to the high-order two bits “10”) that have been read is “0100”, the table T2 is referred to using the value “0100” of the four bits that have been read as a key, which dictates “−1” as the table number of a table to be referred to next. Accordingly, table reference is finished at this level, and an output probability for the feature data yk is obtained based on the table T2.

Thus, the high-order two bits “10” of the feature data yk in the example of FIG. 6 corresponds to the segment C, in which an output probability for the feature data yk must be obtained with high precision. Therefore, an output probability can be obtained for each possible feature data yk in the segment C.

Also with regard to the segment D, an output probability can be obtained according to the procedure described earlier in relation to the first method, and description thereof will be omitted. In the segment A, a constant output probability is output.

Although an example of obtaining an output probability for feature data yk by the first method has been described above, it is to be understood that an output probability can be obtained by the second method as well. That is, in this case, an output probability for feature data yk is obtained by linearly approximating an output probability curve in the segment B if the feature data yk resides in the segment B in FIG. 6, which can be implemented by the process described in relation to the second method, and description thereof will be omitted.

Since distribution of output probability differs among the respective states of HMM, setting of a segment that requires an output with high precision and a segment that allows some error, and setting of resolution of output probability to be obtained are made on a state-by-state basis.

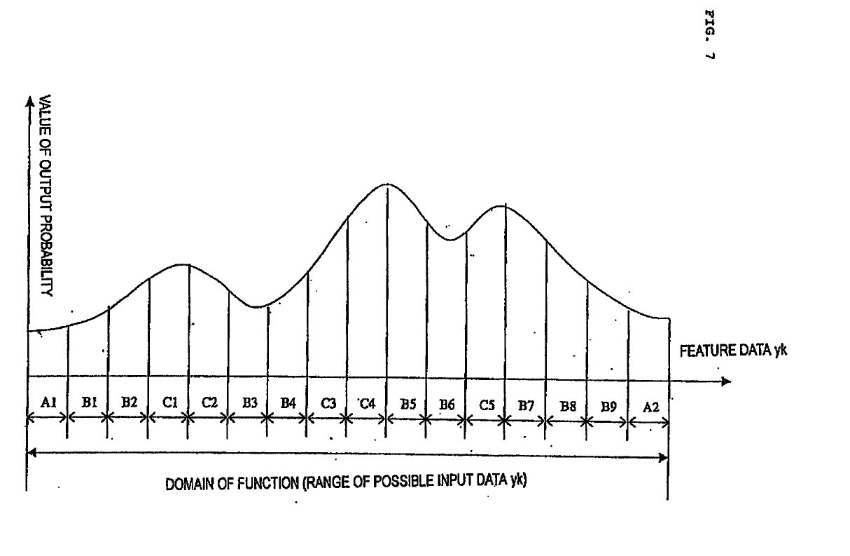

The present invention can also be applied to a mixed continuous distribution HMM. FIG. 7 shows an example of distribution of output probability of a mixed continuous distribution HMM. Conventionally, in the distribution of output probability of a mixed continuous distribution HMM, when an output probability of feature data yk of a dimension k of a feature vector at a time is to be calculated by a function, calculation must be performed for each distribution and the sum of the results must be obtained, which is very laborious and computationally intensive.

According to the present invention, in an example shown in FIG. 7, in the output probability distribution curve of a mixed continuous distribution HMM, a range of possible feature data is divided equally, for example, into sixteen segments; namely, segments C1 to C5 in which precision is required, segments B1 to B9 in which some error is allowed, and segments A1 and A2 in which a constant value is output.

In the output probability distribution curve of a mixed continuous distribution HMM as well, an output probability for feature data yk can be obtained by employing the first method and the second method described earlier. In this case, since a range of possible feature data yk is equally divided into sixteen segments, which of the segments input feature data resides in can be determined by reading the high-order four bits.

The arrangement is such that if the feature data yk resides in one of the segments C1 to C5, an output probability is obtained with high precision, for example, an output probability for each possible feature data yk can be obtained; if the feature data yk resides in one of the segments B1 to B9, an output probability is obtained on a segment basis, similarly to the first method described earlier, or an output probability is obtained by linear approximation as in the second method; if the feature data yk resides in one of the segments A1 and A2, a preset constant output probability is obtained.

As described above, also in a mixed continuous distribution HMM, calculation of an output probability can be implemented by employing the first method or second method described earlier. When the first method is employed, tables in accordance with output probability distribution of the mixed continuous HMM are created and a process equivalent to the process described earlier is executed, allowing an output probability to be obtained only by table reference.

When the first method is employed, several table references suffice. In addition, tables are such that an output corresponding to feature data yk that requires precision is obtained with high precision while an output corresponding to feature data yk that allows some error is obtained within an allowable range of error, that is, an output of a resolution in accordance with feature data yk is obtained. Accordingly, table sizes are minimized, and an output probability is obtained with high precision and with error suppressed, achieving a high recognition rate.

When the second method is employed, in the segments B1 to B9, in which some error is allowed, an output probability is obtained by linearly approximating an output probability curve in the relevant segment, as described earlier.

Even when the second method is employed, it suffices to add simple calculation for obtaining an approximate value. Furthermore, an output probability is obtained with high precision and with error suppressed, achieving a high recognition rate.

The present invention is not limited to the embodiments described hereinabove, and various modifications are possible without departing from the spirit of the present invention. For example, although the embodiments have been described in the context of an example where the present invention is applied to calculation of an HMM output probability, the present invention can be generally applied to data calculation for obtaining a value corresponding to input data by assigning the input data to a function that requires a complex algorithm.

Furthermore, an HMM output probability can be obtained by equation (1) given earlier when it is to be obtained by calculating a function; however, direct calculation using equation (1) may cause a value obtained by the calculation to be too small, causing an underflow. Accordingly, calculation is usually performed by taking logarithm of equation (1), and it is to be understood that the present invention may be applied to a case where logarithm is taken.

Furthermore, according to the present invention, a processing program defining a processing procedure for implementing the present invention described hereinabove may be created and recorded on a recoding medium such as a floppy disk, an optical disk, or a hard disk, and the recording medium having the processing program recorded thereon is within the scope of the present invention. Alternatively, the processing program may be obtained via a network.

As described hereinabove, according to the present invention, a range of possible input data is divided into at least a segment in which an output value corresponding to the input data must be obtained with high precision and a segment in which some error is allowed, it is determined which segment the input data resides in, and an output value of a resolution in accordance with a segment determined is obtained only by table reference or simple approximating calculation, so that complex calculation, which has conventionally been required, is unnecessary, and a memory area occupied in data calculation for obtaining an output value is reduced. Furthermore, since an output of a resolution in accordance with input data is obtained, an output for input data that requires precision is obtained with high precision while an output for input data that allows some error is obtained within an allowable range of error. Accordingly, subsequent data processing using the output value is executed with high precision.

Thus, the present invention is particularly advantageous, for example, when applied to calculation of an output probability in an HMM, such that an output probability of feature data that requires precision is obtained with high precision while an output probability of feature data that allows some error is obtained within an allowable range of error, that is, an output probability of a resolution in accordance with input feature data is obtained. A process for obtaining an output probability can be implemented by only sequential reference to hierarchically structured tables or simple approximating calculation, so that an output probability is obtained quickly with a small amount of computation, and an output probability is obtained with high precision for a part that requires precision, achieving a good ability of recognition.

1) a data calculation processing method that allows data calculation for obtaining an output value corresponding to input data by assigning the input data to a function to be executed in a simplified manner,
wherein a range of possible input data is divided at least into a segment in which an output value corresponding to the input data must be obtained with high precision and a segment in which some error is allowed, it is determined which segment the input data resides in, and an output value of a resolution in accordance with a segment determined is obtained.

2) A data calculation processing method according to claim 1, wherein the segment in which an output value corresponding to the input data must be obtained with high precision and the segment in which some error is allowed exist in association with combinations of high-order n bits (n is a positive integer, and is smaller than the number of bits N of the input data) of the input data in binary representation, and whether a segment associated with a combination of bits is the segment in which an output value corresponding to the input data must be obtained with high precision or the segment in which some error is allowed is predetermined.

3) A data calculation processing method according to claim 2, wherein a process of determining which segment the input data resides in and obtaining an output value of a resolution in accordance with a segment determined is executed by sequentially referring to tables of a group of hierarchically structured tables, and a process of sequentially referring to the hierarchically structured tables is such that:
a process of reading the high-order n bits of the input data in binary representation, referring to a top table of the group of hierarchically structured tables using contents of the n bits as a key, obtaining information of a table to be referred to next if a table to be referred to next is dictated in the top table and obtaining the number of bits to be read subsequent to the high-order n bits if the number of bits to be read is dictated in the top table, and referring to the table to be referred to using contents of bits of the input data corresponding to the number of bits to be read as a key is repeated until reaching a terminal table in which a table to be referred to next is not dictated, and the terminal table is referred to using contents of bits of the input data corresponding to the number of bits to be read as dictated in a table immediately preceding the terminal table as a key, thereby obtaining an output value corresponding to the input data.

4) A data calculation processing method according to one of claims 1 to 3, wherein output values corresponding to input data in the segment in which an output value must be obtained with high precision are output values corresponding to individual possible values of input data in the segment, and the output values are dictated in a terminal table in association with the individual possible values of input data in the segment.

5) A data calculation processing method according to one of claims 1 to 3, wherein output values corresponding to input data in the segment in which some error is allowed are an output value for the segment in which some error is allowed or output values for respective segments formed by further dividing the segment, and the output values are dictated in a terminal table in association with the respective segments.

6) A data calculation processing method according to claim 1 or 2, wherein an output value corresponding to input data in the segment in which some error is allowed is obtained by approximating a function curve in the segment.

7) A data calculation processing method according to claim 6, wherein linear approximation is used as a method of approximating the function curve.

8) A data calculation processing method according to one of claims 1 to 7, wherein a segment in which a predetermined constant value is used as an output value corresponding to input data is provided in addition to the segment in which an output value corresponding to the input data must be obtained with high precision and the segment in which some error is allowed.

9) A data calculation processing method according to one of claims 1 to 8, wherein data calculation for obtaining an output value corresponding to input data according to a predetermined algorithm by assigning the input data to a function is used for calculation for obtaining an output probability in an HMM.

10) A recording medium having recorded thereon a data calculation processing program that allows data calculation for obtaining an output value corresponding to input data by assigning the input data to a function to be executed in a simplified manner, the data calculation processing program defining a procedure such that:
a range of possible input data is divided at least into a segment in which an output value corresponding to the input data must be obtained with high precision and a segment in which some error is allowed, it is determined which segment the input data resides in, and an output value of a resolution in accordance with a segment determined is obtained.

11) A recording medium having recorded thereon a data calculation processing program according to claim 10, wherein the segment in which an output value corresponding to the input data must be obtained with high precision and the segment in which some error is allowed exist in association with combinations of high-order n bits (n is a positive integer, and is smaller than the number of bits N of the input data) of the input data in binary representation, and whether a segment associated with a combination of bits is the segment in which an output value corresponding to the input data must be obtained with high precision or the segment in which some error is allowed is predetermined.

12) A recording medium having recorded thereon a data calculation processing program according to claim 11, wherein a process of determining which segment the input data resides in and obtaining an output value of a resolution in accordance with a segment determined is executed by sequentially referring to tables of a group of hierarchically structured tables, and a process of sequentially referring to the hierarchically structured tables is such that:
a process of reading the high-order n bits of the input data in binary representation, referring to a top table of the group of hierarchically structured tables using contents of the n bits as a key, obtaining information of a table to be referred to next if a table to be referred to next is dictated in the top table and obtaining the number of bits to be read subsequent to the high-order n bits if the number of bits to be read is dictated in the top table, and referring to the table to be referred to using contents of bits of the input data corresponding to the number of bits to be read as a key is repeated until reaching a terminal table in which a table to be referred to next is not dictated, and the terminal table is referred to using contents of bits of the input data corresponding to the number of bits to be read as dictated in a table immediately preceding the terminal table as a key, thereby obtaining an output value corresponding to the input data.

13) A recording medium having recorded thereon a data calculation processing program according to one of claims 10 to 12, wherein output values corresponding to input data in the segment in which an output value must be obtained with high precision are output values corresponding to individual possible values of input data in the segment, and the output values are dictated in a terminal table in association with the individual possible values of input data in the segment.

14) A recording medium having recorded thereon a data calculation processing program according to one of claims 10 to 12, wherein output values corresponding to input data in the segment in which some error is allowed are an output value for the segment in which some error is allowed or output values for respective segments formed by further dividing the segment, and the output values are dictated in a terminal table in association with the respective segments.

15) A recording medium having recorded thereon a data calculation processing program according to claim 10 or 11, wherein an output value corresponding to input data in the segment in which some error is allowed is obtained by approximating a function curve in the segment.

16) A recording medium having recorded thereon a data calculation processing program according to claim 15, wherein linear approximation is used as a method of approximating the function curve.

17) A recording medium having recorded thereon a data calculation processing program according to one of claims 10 to 16, wherein a segment in which a predetermined constant value is used as an output value corresponding to input data is provided in addition to the segment in which an output value corresponding to the input data must be obtained with high precision and the segment in which some error is allowed.

18) A recording medium having recorded thereon a data calculation processing program according to one of claims 10 to 17, wherein data calculation for obtaining an output value corresponding to input data according to a predetermined algorithm by assigning the input data to a function is used for calculation for obtaining an output probability in an HMM.
